(19) United States
(12) Patent Application Publication
(10) Pub. No.: US 2023/0030456 A1
(43) Pub. Date: Feb. 2, 2023

(54) Transmission and Drive System of a Motor Vehicle

(71) Applicant: ZF Friedrichshafen AG, Friedrichshafen (DE)

(72) Inventors: Johannes Kaltenbach, Friedrichshafen (DE); Martin Brehmer, Tettnang (DE); Fabian Kutter, Kressbronn (DE); Matthias Horn, Tettnang (DE); Stefan Beck, Eriskirch (DE)

(21) Appl. No.: 17/788,390

(22) PCT Filed: Mar. 23, 2021
(86) PCT No.: PCT/EP2021/057359

§ 371 Date: Jun. 23, 2022

(30) Foreign Application Priority Data
Apr. 22, 2020 (DE) 10 2020 205 093.7

(51) Int. Cl. B60K 6/365; B60K 6/387; F16H 37/06; B60K 6/547; B60K 6/442

(52) U.S. Cl. CPC B60K 6/365; B60K 6/387; F16H 37/065; B60K 6/547; B60K 6/442; B60Y 2200/92

(57) ABSTRACT

A transmission (2) of a motor vehicle includes a first sub-transmission (5) having a first input shaft (7) and a countershaft (11) coupled to the first input shaft (7) via a constant ratio. The transmission further includes a second sub-transmission (6) having a second input shaft (8) and being a planetary transmission having a sun gear (24), a ring gear (22), and a carrier (23). The transmission also includes an output shaft (9) and an engaging device (S3). A first ratio for the second prime mover (4) is formed in a first engagement position (E) of the engaging device (S3), a second ratio for the second prime mover (4) is formed in a second engagement position (F) of the engaging device (S3), and at least one third ratio for the second prime mover (4) is formed in a third engagement position (N) of the engaging device (S3).

### CROSS-REFERENCE TO RELATED APPLICATION

The present application is related and has right of priority to German Patent Application No. 10 2020 205 093.7 filed on Apr. 22, 2020 and is a nationalization of PCT/EP2021/057359 filed in the European Patent Office on Mar. 23, 2021, both of which are incorporated by reference in their entirety for all purposes.

### FIELD OF THE INVENTION

The invention relates generally to a transmission of a motor vehicle. In addition, the invention relates generally to a transmission system of a motor vehicle.

### BACKGROUND

US 2017/0129323 A1 describes a transmission of a motor vehicle, particularly a hybrid vehicle. The transmission includes a first input shaft, to which a first prime mover is coupleable, and a second input shaft, to which a second prime mover is coupleable. Moreover, the transmission includes an output shaft, to which a drive output is coupleable. The first input shaft is an integral part of a first sub-transmission for the first prime mover. The second input shaft is an integral part of a second sub-transmission for the second prime mover. Each of the sub-transmissions is a spur gear drive according to US 2017/0129323 A1. The two sub-transmissions are coupleable to one another via a shift element arranged on a countershaft.

The transmission according to US 2017/0129323 A1 needs a relatively large installation space and has a relatively high weight.

### SUMMARY OF THE INVENTION

A new type of transmission of a motor vehicle and a transmission system having the new type of transmission are provided herein.

The transmission includes a first input shaft for a first prime mover.

In addition, the transmission includes a second input shaft for a second prime mover.

Moreover, the transmission includes an output shaft.

The transmission has a first sub-transmission for the first prime mover. The first sub-transmission includes the first input shaft and a countershaft coupled to the first input shaft via a constant ratio.

The transmission has a second sub-transmission, which includes the second input shaft, for the second prime mover, wherein the second sub-transmission is a planetary transmission having a sun gear, a ring gear, and a carrier.

An engaging device is associated with the second drive device, wherein at least one first ratio for the second drive device is formed in a first engagement position of the engaging device, a second ratio for the drive device is formed in a second engagement position of the engaging device, and at least one third ratio for the second drive device is formed in a third engagement position of the engaging device.

Due to the engaging device, therefore, different ratios and, thus, an improved utilization of the second prime mover are obtained.

Preferably, there is precisely one first ratio and/or precisely one second ratio and/or precisely two third ratios. Preferably, the first ratio is the highest ratio and/or the second ratio is a middle ratio and/or the third ratios are the lowest ratios.

Preferably, in the first engagement position, the second prime mover couples with the second sub-transmission. Preferably, in the second engagement position, the second prime mover is directly coupleable to the second input shaft of the second sub-transmission such that the second prime mover is directly operatively connected to the second input shaft of the second sub-transmission. Advantageously, in the third engagement position, the second prime mover is coupleable with the first sub-transmission.

Due to the different connections, the resultant different ratios at the output are obtained. As a result, the second prime mover coves wide ranges of use.

Preferably, the ring gear forms the second input shaft of the second sub-transmission.

In addition, the carrier is permanently coupled to the output shaft and to a gearwheel arranged on the output shaft. Alternatively, the connection takes place via a shift element.

Advantageously, the sun gear is permanently fixedly connected to the housing.

These embodiments yield an advantageous ratio for the connection of the second prime mover to the second sub-transmission.

Preferably, the planetary transmission has one single planetary gear set. This is intended primarily to clarify that the planetary transmission does not have multiple planetary gear sets.

Preferably, gearwheels are on the countershaft, which engage exclusively into gearwheels arranged coaxially to the first input shaft, wherein at least some of the gearwheels arranged coaxially to the first input shaft engage into gearwheels arranged on the output shaft, wherein shift elements are associated with the first input shaft as well as with the countershaft that, depending on their engagement position for the first prime mover, provide either a gear having a first number of instances of gearwheel meshing or a winding-path gear having a second, larger number of instances of gearwheel meshing.

The first sub-transmission for the first prime mover is a spur gear drive having intermeshing gearwheels, where the first prime mover is preferably an internal combustion engine. Gearwheels arranged on the countershaft mesh exclusively into gearwheels that are arranged coaxially to the first input shaft of the first sub-transmission. As a result, the countershaft is freely positioned in space in relation to the first input shaft. Depending on the engagement position of the shift elements associated with the first sub-transmission, namely the countershaft and the first input shaft, the first sub-transmission provides either a conventional gear with a first number, in particular two, of gearwheels meshing or a winding-path gear with a second number, namely with four, of gearwheels meshing.

The second sub-transmission for the second prime mover is a planetary transmission, where the second prime mover is preferably an electric machine.

A particularly compact design is implemented for the transmission according to the invention. This is due to, among other things, the fact that the second sub-transmission is a planetary transmission and the countershaft is freely positioned in space in relation to the first input shaft and does not mesh with the output shaft. The countershaft and the output shaft are relatively short due to the second sub-transmission being a planetary transmission. One further installation space-related advantage is implemented when the shift elements associated with the second sub-transmission are part of a double shift element.

According to one advantageous refinement, the carrier of the planetary transmission is permanently coupled to the output shaft via a gearwheel arranged coaxially to the first input shaft.

According to one advantageous refinement, a third prime mover is present, which is an electric machine, wherein the third prime mover is operatively connected to the first input shaft. For the case in which a further, third prime mover is present, which is preferably an electric machine, as is the case with the second prime mover, further advantages are achieved. Thus, in particular, the third prime mover as an electric machine is operable as a starter generator and improves the function of the transmission and/or of the transmission system including the transmission. For the case in which a separating clutch is additionally present between the first prime mover and the first input shaft, where the first prime mover is an internal combustion engine, purely electric powershifts are provided when the separating clutch is disengaged. As a result, the operation of a transmission system including the transmission is further improved.

### BRIEF DESCRIPTION OF THE DRAWINGS

Preferred refinements result from the dependent claims and the following description. Exemplary embodiments of the invention are explained in greater detail with reference to the drawing, without being limited thereto, in which:

FIG. 1 shows a diagram of a transmission system of a motor vehicle with a first exemplary embodiment of a transmission;

FIG. 2 shows a gear shift matrix of the transmission system from FIG. 1;

FIG. 3 shows a list of exemplary ratio values of a transmission system with a first exemplary embodiment of a transmission;

FIG. 4 shows a diagram of a transmission system of a motor vehicle with a second exemplary embodiment of a transmission; and

FIG. 5 shows a diagram of a transmission system of a motor vehicle with a third exemplary embodiment of a transmission.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

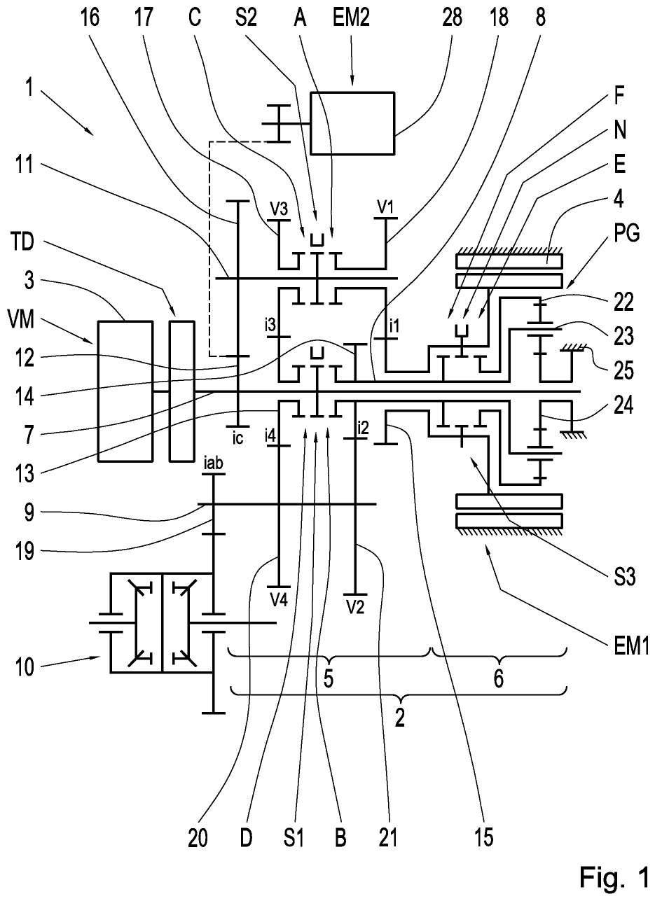

FIG. 1 shows a diagram of a transmission system 1 of a motor vehicle according to the invention, which includes a transmission 2 according to the invention.

The transmission system 1 includes, in addition to the transmission 2, a first prime mover 3 and a second prime mover 4. The first prime mover 3 is preferably an internal combustion engine and the second prime mover 4 is preferably an electric machine. Thus, the transmission system from FIG. 1 is a hybrid transmission system.

The transmission 2 includes two sub-transmissions 5, 6. The first sub-transmission 5 acts as a sub-transmission for the first prime mover 3, where the first prime mover 3 is preferably an internal combustion engine. The first prime mover 3 is coupleable to a first input shaft 7 of the first sub-transmission 5 of the transmission 2.

In some embodiments, a damping device TD is arranged between the internal combustion engine VM and the first input shaft 7. The damping device TD includes a torsion damper and/or a damper and/or a slipping clutch, where the torsion damper is a dual-mass flywheel, and the damper is a rotational speed-adaptive damper.

A second sub-transmission 6 acts as a sub-transmission in particular for the second prime mover 4, where the second prime mover 4 is an electric machine, and where the second prime mover 4 is also coupleable to a second input shaft 8 of the transmission 2, the second input shaft 8 being provided by the second sub-transmission 6.

In addition, the transmission 2 includes an output shaft 9, which is common to both sub-transmissions 5, 6 and to which a drive output 10 is coupled. A differential is part of the drive output 10.

The first sub-transmission 5 includes, in addition to the first input shaft 7, a countershaft 11. The first prime mover 3 (preferably as an internal combustion engine) is permanently coupled to the countershaft 11 in the exemplary embodiment shown from FIG. 1. The countershaft 11 extends in parallel to the first input shaft 7, is coupled to the first input shaft 7 via a constant ratio ic, and includes gearwheels 16, 17, 18, which mesh exclusively and respectively with gearwheels 12, 13, and 15 arranged coaxially to the first input shaft 7. Thus, the countershaft 11 has no gearwheel meshing with the output shaft 9 and/or the differential 10, as the result of which the countershaft 11 is advantageously located in relation to the first input shaft 7, and, in fact, is arrangeable nearly arbitrarily freely in space, provided a geometric collision with other assemblies does not arise.

The gearwheels 12, 13, 14, 15 are positioned coaxially to the first input shaft 7. The gearwheel 12 is a fixed gear coupled to the first input shaft 7 in a rotationally fixed manner. The gearwheels 13, 14, however, are idler gears. The gearwheel 15 is not a fixed gear with respect to the second input shaft 8 since there is no rotationally fixed connection. The gearwheel 15 is also not an idler gear, however, since a shift element is not provided for connecting the gearwheel 15 to the second input shaft 8. The gearwheel 15 is therefore mounted exclusively on the second input shaft 8.

Two shift elements B, D are associated with the first input shaft 7. These two shift elements B, D are preferably part of a double shift element, first engaging device 51, wherein only one of these shift elements B, D is ever engaged at a time.

When the shift element D is engaged, the idler gear 13 is coupled to the first input shaft 7 in a rotationally fixed manner. When the shift element B is engaged, however, the gearwheel 14 is coupled to the first input shaft 7 in a rotationally fixed manner.

As mentioned above, the countershaft 11 is engaged with the first input shaft 7 via the constant ratio ic. Particularly, the fixed gear 16, which meshes with the fixed gear 12 of the first input shaft 7, is associated with the countershaft 11.

In addition, the countershaft 11 supports the idler gears 17, 18, wherein the idler gear 17 of the countershaft 11 meshes with the idler gear 13 of the first input shaft 7, whereas the idler gear 18 of the countershaft 11 meshes with the gearwheel 15.

Two shift elements A, C are associated with the countershaft 11 and are preferably part of a double shift element, engaging device S2, and so only one of these shift elements A, C is ever engaged at a time.

When the shift element C is engaged, the idler gear 17 of the countershaft 11 is rotationally fixed to the countershaft 11. However, when the shift element A is engaged, the idler gear 18 of the countershaft 11 is rotationally fixed to the countershaft 11.

The gearwheels 16, 17, 18 of the countershaft 11 mesh, as mentioned above, exclusively into gearwheels positioned coaxially to the first input shaft 7, namely into the gearwheels 12, 13, 15, respectively. The gearwheels 16, 17, 18 of the countershaft 11 do not mesh into gearwheels 19, 20, 21 of the output shaft 9. The gearwheels 19, 20, 21 of the output shaft 9 are all fixed gears of the output shaft 9. The gearwheel 19 meshes into the differential of the drive output 10. The gearwheel 20 meshes into the idler gear 13 of the first input shaft 7, and the gearwheel 21 meshes into the idler gear 14 of the first input shaft 7.

Accordingly, the first sub-transmission 5 for the first prime mover 3 is a spur gear drive made up of intermeshing gearwheels, where the first prime mover 3 is preferably an internal combustion engine. Depending on the engagement position of the shift elements A, B, C, D associated with the first sub-transmission 5, either conventional gears with a first number of gearwheels meshing, namely with two gearwheels meshing, or a winding-path gear with a larger, second number of gearwheels meshing, namely with four gearwheels meshing, is made available, wherein the winding-path gear with the four meshing gearwheels is the gear in which the shift element C is engaged.

An engaging device S3 is utilized for connecting the second prime mover 4, the engaging device S3 having shift elements E, F. If the engaging device S3 is in a neutral position N, where neither of its shift elements E, F is engaged, the second prime mover 4 is coupled exclusively via the gearwheel 15 to the idler gear 18 and, thus, to the first sub-transmission 5. Then, when the shift element A is engaged, a connection from the second prime mover 4 to the countershaft 11 is established.

If the engaging device S3 is in a second engagement position, the shift element F is engaged and the second prime mover 4 is directly coupled to the second input shaft 8.

If the engaging device S3 is in a first engagement position, the shift element E is engaged and the second prime mover 4 is connected to the second sub-transmission 6. The second sub-transmission 6 for the second prime mover 4 is a planetary transmission PG including a ring gear 22, a carrier 23, and a sun gear 24, where the second prime mover 4 is preferably an electric machine EM1. When the shift element E is engaged, the second prime mover 4 is particularly connected to the ring gear 22. The sun gear 24 is permanently fixed to the housing and the carrier 23 forms the output, which couples to the drive output 9 via the gearwheel 14.

A third engagement position of the engaging device S3 is a neutral position.

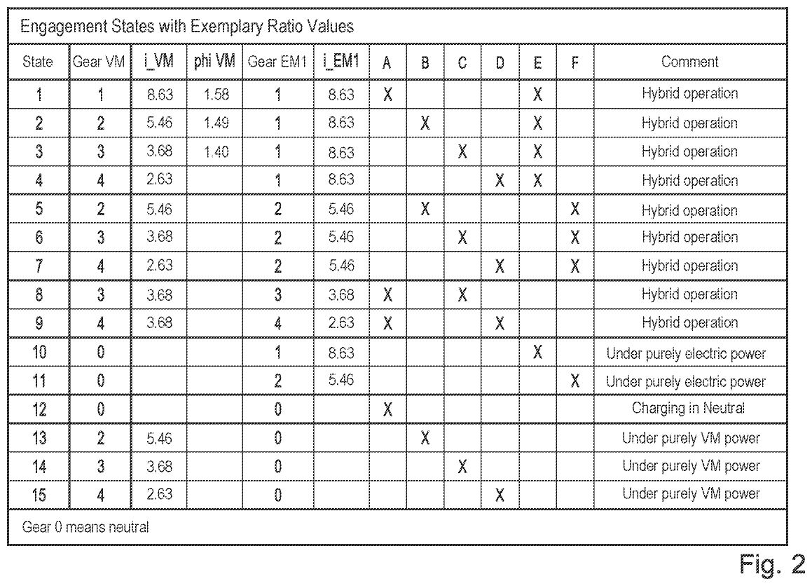

The gear shift matrix from FIG. 2 shows that a gear VM3 is a winding-path gear. Gears VM2, VM4, however, are conventional gears with only two instances of gearwheel meshing.

FIG. 2 shows a first ratio of 8.63 (shift element E engaged, states 1-4), a second ratio of 5.46 (shift element F engaged, states 5-7), and third ratios of 2.63 and 3.68 in the neutral position of the engaging device S3 (states 8-9).

The ring gear 22 of the planetary transmission PG is connectable to the electric machine EM1. In FIG. 1, the electric machine EM1, is the second prime mover 4, is positioned coaxially to the planetary transmission PG such that the planetary transmission PG is arranged nested in the rotor of the electric machine EM1.

The output side of the planetary transmission 6 is formed by the carrier 23, which is permanently coupled to the output shaft 9.

FIG. 1 shows that the carrier 23 of the planetary transmission and/or of the second sub-transmission 6 is fixedly coupled to the idler gear 14 and, via the idler gear 14, fixedly and/or permanently coupled to the output shaft 9, namely to the fixed gear 21 thereof.

The idler gears 17, 18 of the countershaft 11 are coupleable to the countershaft 11 in a rotationally fixed manner depending on the engagement position of the shift elements C, A, respectively, and are thus operatively connected to the output shaft 9 via the idler gears 13, 14 of the first input shaft 7, respectively, which, depending on the engagement position of the shift elements D, B, respectively are coupleable to the first input shaft 7 in a rotationally fixed manner. The gearwheels 16, 17, 18 of the countershaft 11 mesh exclusively into the gearwheels 12, 13, 15 positioned coaxially to the first input shaft 7, however, and not into gearwheels of the output shaft 9.

The shift elements E, F of the engaging device S3 are associated with the second sub-transmission 6.

In summary, the following is said about the embodiment according to FIG. 1:

The ring gear 22 represents the input of the planetary transmission PG and the carrier 23 represents the output. The sun gear 24 is permanently fixed to the housing. The rotor of the electric machine EM1 is switchable between being connected to the ring gear 22 and the carrier 23 via the double shift element, engaging device S3 having the shift elements E,F. In a first electric gear E1, the electric machine EM1 is connected by the shift element E to the ring gear 22. In a second electric gear E2, the electric machine EM1 is connected by the shift element F to the carrier 23. The carrier 23 is permanently connected to the input shaft 8. The planetary transmission PG cannot be decoupled.

The following also applies:
from the first input shaft 7, two gears are directly engageable onto the output shaft 9 via 2 meshing points, the shift elements B, D, which belong to the sub-transmission 5 for the internal combustion engine VM.
the countershaft 11 is driven with the constant ratio ic.
there is a so-called winding-path gear, which is engaged with the shift element C. The power flow is guided to the output shaft 9 with a diversion via the countershaft 11. There are 4 meshing points.
there is a sub-transmission coupling via the countershaft 11 with shift element A. Here, the internal combustion engine VM and the electric machine EM1 are connected to each other with a fixed speed ratio. Thus, the internal combustion engine VM also utilizes the gears of the electric machine EM1 and vice versa. The first VM gear state 1 in the gear shift matrix from FIG. 2) makes use of the first electric gear E1 (.
a plurality of engagement states is possible including operation under purely electric power, operation under purely internal combustion engine power, and hybrid operation.
the two electric gears E1, E2 are not power shiftable with one another.
in the hybrid operation, powershifts are possible due to electric tractive force support.

The following advantages result:
the countershaft 11 is freely pivotable in space since it does not intermesh with the differential.
the small electric gear E2 is combinable with all 4 internal combustion engine gears and the higher electric gear is combinable with the internal combustion engine gears 2, 3, 4 (Gear VM 2, 3, 4).
the output shaft 9 is short (only 2 spur gear planes, not counting the output to the differential).
due to a coaxial electric machine EM1, the planetary transmission PG is nested in the rotor of the electric machine EM1.

The transmission 2 is utilized for a driving operation under purely electric power, a driving operation under purely internal combustion engine power, and a hybrid operation. The gear shift matrix from FIG. 2 summarizes, with the states 1 through 15, the particular possible driving operations, gears, and exemplary gear stages of the transmission in the particular gears. Shift elements that are engaged in the particular gear and/or state of the transmission 2 are marked with an X in the gear shift matrix from FIG. 2.

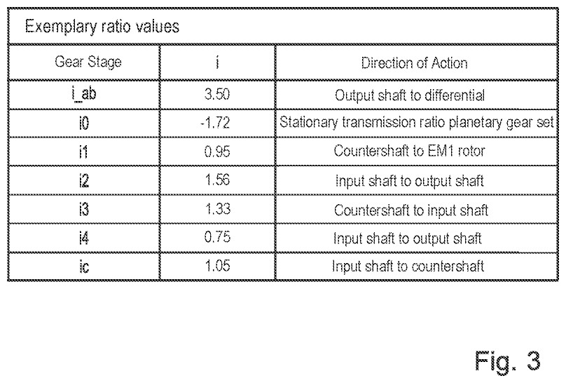

The ratio values in the gear shift matrix from FIG. 3 are merely examples.

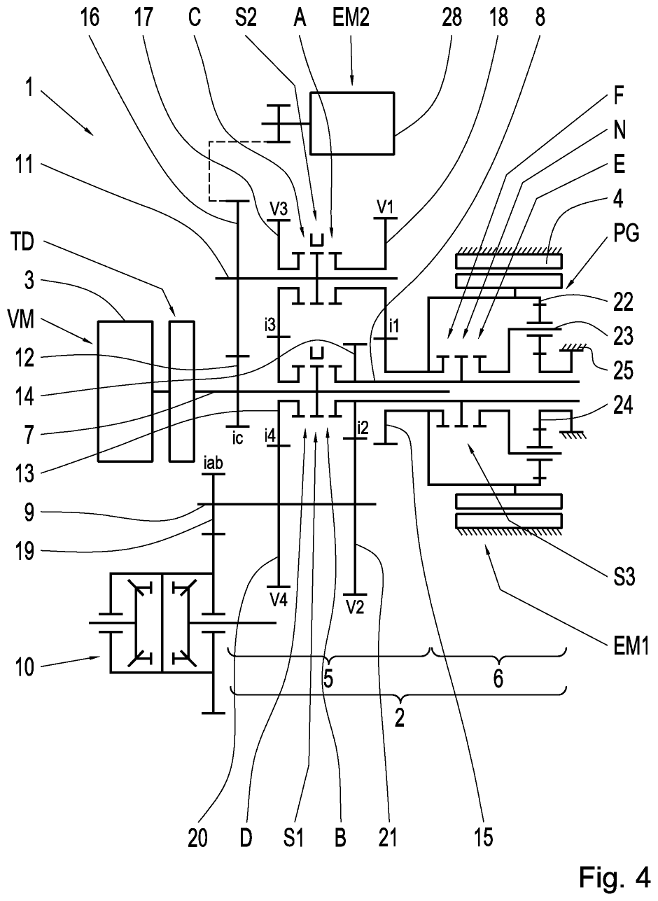

FIG. 4 shows a modification of the exemplary embodiment from FIG. 1, in which the sun gear 24 is still permanently fixed to the housing. The electric machine EM1 is instead connected to the ring gear 22. The shift element E connects the second input shaft 8 to the carrier 23, enabling the first electric gear E1 to be engaged. The shift element F instead connects the second input shaft 8 to the ring gear 22 and to the rotor of the electric machine EM1, enabling the second electric gear E2 to be engaged. The second input shaft 8 is permanently connected to the drive output 9 (via a spur gear stage i2, which represents the gear V2). The shift elements E/F are combined as a double shift element.

As a result, when both shift elements E, F are disengaged, both the electric machine EM1 and the planetary transmission are decoupled and cause no drag losses during the driving operation under purely internal combustion engine power (states 13-15 in FIG. 2). “Under purely internal combustion engine VM power” means that the large electric machine EM1 is decoupled. The smaller electric machine EM2 rotates, however, provided that it is present.

The shift elements E, F are actuatable, for example, from the inside, from the end of the transmission.

According to one further modification (not represented), the electric machine EM2 is connected to the countershaft 11, for example, via an intermediate gear. The modification is functionally equivalent to the embodiment according to FIG. 1, since the countershaft 11 is permanently operatively connected to the internal combustion engine VM.

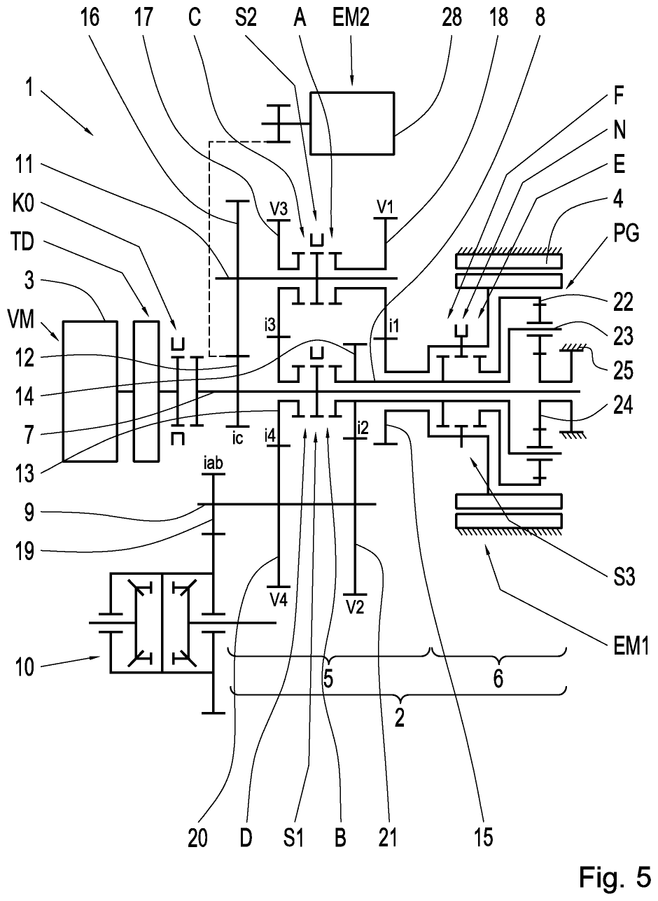

FIG. 5 shows one further modification of the exemplary embodiment from FIG. 1, in which a separating clutch KO for the internal combustion engine VM is included. The separating clutch KO is a dog clutch or, alternatively, a friction clutch. The provision of the separating clutch KO has the following advantages:
with the separating clutch KO disengaged, a purely electric driving operation with the electric machine EM2 is possible (use of the gears V1, V2, V3, V4).
a driving operation under purely electric power with the electric machine EM1 and the electric machine EM2 together is possible, wherein the particular gears are combinable in any way.
in the driving operation under purely electric power (the separating clutch KO disengaged), the electric machine EM2 assists the tractive force while EM1 changes the gear.
in the driving operation under purely electric power (the separating clutch KO disengaged), the electric machine EM1 assists the tractive force while the electric machine EM2 changes the gear.

If the separating clutch KO is a friction clutch, further advantages result:
the separating clutch KO is also disengageable under load, for example, during a full application of the brakes or a malfunction of the internal combustion engine VM.
the separating clutch KO is also engageable under differential speed, and so a so-called “flywheel start” of the internal combustion engine VM with the electric machine EM2 is possible (utilization of the inertial mass of the electric machine EM2 to start the internal combustion engine).

All embodiments have the following features:

The electric machine EM1 is mountable in entirety at the end of the transmission. An actuator for actuating the engaging device S3 having the shift elements E/F reaches the double shift element S3 on the transmission side or,in one variant, alternatively, from the inside, from the end of the transmission (see FIG. 4). This is useful, in particular, given a particularly large and powerful electric machine EM1, when both the engaging device S3 as well as the planetary transmission PG are radially nestable at least partially within the rotor of the electric machine EM1. This has the advantage that axial installation space is saved.

The input shaft 7 does not need to extend to the end of the transmission 2. The input shaft 7 can end at the shift element B or at the spur gear stage i1. It is structurally useful, however, for mounting-related reasons, to lengthen the input shaft 7 as indicated in the diagram.

It is advantageous to provide an additional starter generator EM2 fixedly connected to the internal combustion engine VM, since charging at a standstill is not possible with the electric machine EM1.

The electric machine EM2 is preferably connected with an intermediate gear to the stage ic.

Alternatively, the electric machine EM2 is connected, as a coaxial electric machine, to the input shaft 7.

Alternatively, the electric machine EM2 is mounted at the belt drive of the internal combustion engine VM.

The following functions are covered with the electric machine EM2, provided that the electric machine EM2 is present:
internal combustion engine start during purely electric driving.
supply of the vehicle electrical system.
serial creeping and serial driving forward/backwards, where the electric machine EM2 generates current for the electric machine EM1 in the engagement states 9 and 10.
support of the closed-loop control of the rotational speed of the internal combustion engine during coupling and during gear shifts.
a synchronization of constant-mesh shift elements, for example, during gear shifts, is advantageously carried out by closed-loop control of the rotational speed at an electric machine.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 transmission system

2 transmission

3 first prime mover/internal combustion engine

4 second prime mover/electric machine

5 first sub-transmission

6 second sub-transmission

7 first input shaft

8 second input shaft

9 output shaft

10 drive output

11 countershaft

12 fixed gear

13 idler gear

14 idler gear

15 idler gear

16 fixed gear

17 idler gear

18 idler gear

19 fixed gear

20 fixed gear

21 fixed gear

22 ring gear

23 carrier

24 sun gear

25 housing

26 spur gear stage

27 spur gear stage

28 third prime mover/electric machine

A shift element

B shift element

C shift element

D shift element

E shift element

F shift element

K0 separating clutch

S1 engaging device

S2 engaging device

S3 engaging device

1.-10. (canceled)

11. A transmission (2) of a motor vehicle, comprising:
a first sub-transmission (5) comprising a first input shaft (7) and a countershaft (11), the countershaft (11) being coupled to the first input shaft (7) via a constant ratio;
a second sub-transmission (6) including a second input shaft (8), the second sub-transmission (6) being a planetary transmission having a sun gear (24), a ring gear (22), and a carrier (23);
an output shaft (9); and
an engaging device (S3) associated with a second prime mover (4), wherein a first ratio for the second prime mover (4) is formed in a first engagement position (E) of the engaging device (S3), a second ratio for the second prime mover (4) is formed in a second engagement position (F) of the engaging device (S3), and at least one third ratio for the second prime mover (4) is formed in a third engagement position (N) of the engaging device (S3).

12. The transmission of claim 11, further comprising a gearwheel (14) coaxial to the first input shaft (7), the carrier (23) of the planetary transmission being permanently coupled to the output shaft (9) via the gearwheel (14).

13. The transmission of claim 11, wherein the second prime mover (4) is coupled to the first sub-transmission (5) when the engaging device (S3) is in the third engagement position (N).

14. The transmission of claim 11, wherein the second prime mover (4) is coupled to the second sub-transmission (6) when the engaging device (S3) is in the first engagement position (E).

15. The transmission of claim 11, wherein the second prime mover (4) is directly coupleable to the second input shaft (8) of the second sub-transmission (6) when the engaging device (S3) is in the second engagement position (F) such that the second prime mover (4) is directly operatively connected to the second input shaft (8) of the second sub-transmission (6) when the engaging device (S3) is in the second engagement position (F).

16. The transmission of claim 11, wherein the second prime mover (4) is indirectly coupleable to the second input shaft (8) of the second sub-transmission (6) such that the second prime mover (4) is indirectly operatively connected to the second input shaft (8) of the second sub-transmission (6).

17. The transmission of claim 11, wherein the first input shaft (7) is operatively connected to an electric machine (EM2).

18. The transmission of claim 11, further comprising a fixed gear (12) on the first input shaft (7); and
a fixed gear (16) on the countershaft (11),
wherein the fixed gear (12) on the first input shaft (7) that meshes with the fixed gear (16) on the countershaft (11) to provide the constant ratio between the first input shaft (7) and the countershaft (11).

19. The transmission of claim 11, further comprising a separating clutch (K0) associated with the first input shaft (7) for selectively decoupling a first prime mover (3) from the first input shaft (7).

20. A transmission system of a motor vehicle, comprising:
the transmission (2) of claim 11;
a first prime mover (3) coupled or coupleable to the first input shaft (7);
a second prime mover (4) coupled or coupleable to the second input shaft (8); and
a drive output (10) coupled to the output shaft (9).
